(19) United States
(12) Patent Application Publication
(10) Pub. No.: US 2008/0071416 A1
(43) Pub. Date: Mar. 20, 2008

(54) Computerized inventory control system

(75) Inventors: Chih-Chieh Ma, Dasi Township (TW); Yen-Chieh Wang, Pingjhen City (TW); I-Tao Lung, Longtan Township (TW)

Correspondence Address: TROXELL LAW OFFICE PLLC, 5205 LEESBURG PIKE, SUITE 1404, FALLS CHURCH, VA, 22041, US

(73) Assignee: ATOMIC ENERGY COUNCIL-INSTITUTE OF NUCLEAR ENERGY RESEARCH, Taoyuan (TW)

(21) Appl. No.: 11/519,875

(22) Filed: Sep. 13, 2006

(51) Int. Cl. G06F 7/00; G08B 29/00

(52) U.S. Cl. 700/213; 340/506

(57) ABSTRACT

A system for inventory control is computerized. Through the computerization, radwaste drum is easily stored with time saved. The congestion is reduced and a whole storage status is easily acquired so that the maintenance is easily done.

### FIELD OF THE INVENTION

The present invention relates to an inventory control; more particularly, relates to easily processing a waste entry operation of radwaste drum with less time and reduced congestion while a whole status is easily monitored, a storage location is easily inquired and a maintenance is easily done.

### DESCRIPTION OF THE RELATED ART

A prior art of “Automated storehouse” comprises a storehouse, a plurality of horizontal rails, a plurality of vertical rails, a positioning platform cart and a stacker; and an elevator is set for the floors to move up and down carrying goods.

Therein, the storehouse comprises a plurality of floors having a storage space; the floors are set with concave ditches for horizontal rails; and, vertical rails are set on the floors.

The horizontal rails is set in the concave ditches on the floor.

The vertical rails are located along a side or both sides of the horizontal rails; the vertical rails comprises a plurality of parallel rails on the floor; each two vertical rails forms a set of vertical track; and the water-level height of the track is as high as the water-level height of the positioning platform cart.

The positioning platform cart moves a long the horizontal rails; two parallel grooves are set on a surface of the positioning platform to form a track vertically or horizontally joinable.

The stacker comprise an ‘n’-shaped seat and a fork lift, where the stacker is carried on the positioning platform cart or is moved along the vertical rails.

With the above structure, together with an industrial personal computer for a main control, a programmable controller for various module and an infrared communication for remote control, the positioning platform cart carries the stacker and stays right in front of a vertical track. Then the stacker moves along the vertical track to the desired location. The desired floor for a pallet and a waste bucket is then obtained and the fork is elevated to the floor for stacking or moving the pal let and the waste bucket.

Although the above prior art stacks or moves the pallet and the waste bucket without human resource, the operation is complex. The status before and after the storing process is not kept in a database so that the operator can not easily obtain information or process a maintenance later. Hence, the prior arts does not fulfill users' requests on actual use.

### SUMMARY OF THE INVENTION

The main purpose of the present invention is to easily process a waste entry operation of radwaste drum with less time and reduced congestion while a whole status is easily monitored, a storage location is easily inquired and a maintenance is easily done.

To achieve the above purpose, the present invention is a computerized inventory control system, comprising a remote operation unit; a network server unit connected with the remote operation unit to be a communication interface of command from the remote operation unit; a database server unit connected with the network server unit to transfer data and to store data; a control unit connected with the database server unit to receive and transmit command signal from the remote operation unit; and an interface unit connected with the control unit, where the interface unit comprises a dose rate measurement and gamma spectroscopy unit, a crane unit, a conveyor unit, a lift unit and an AGV unit; and the interface unit processes command from the control unit and returns status of the processing of the command to the control unit. Accordingly, a novel computerized inventory control system is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention;

FIG. 2 is the structural view showing the control unit;

FIG. 3 is the structural view showing the interface unit; and

FIG. 4 is the structural view showing the state of use.

### DESCRIPTION OF THE PREFERRED EMBODIMENT

The following description of the preferred embodiment is provided to understand the features and the structures of the present invention.

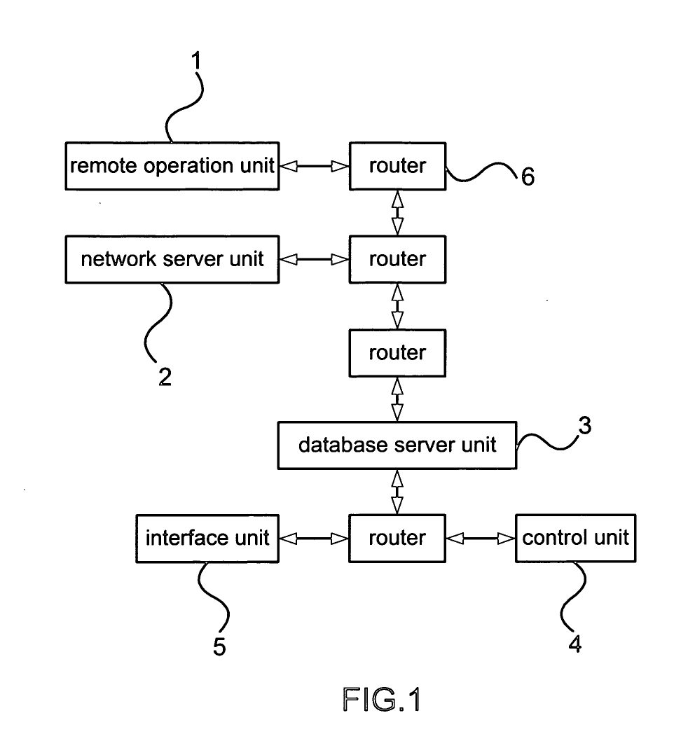

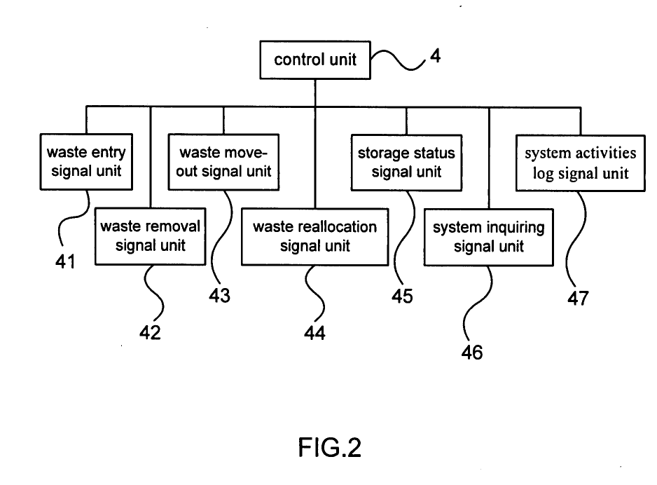

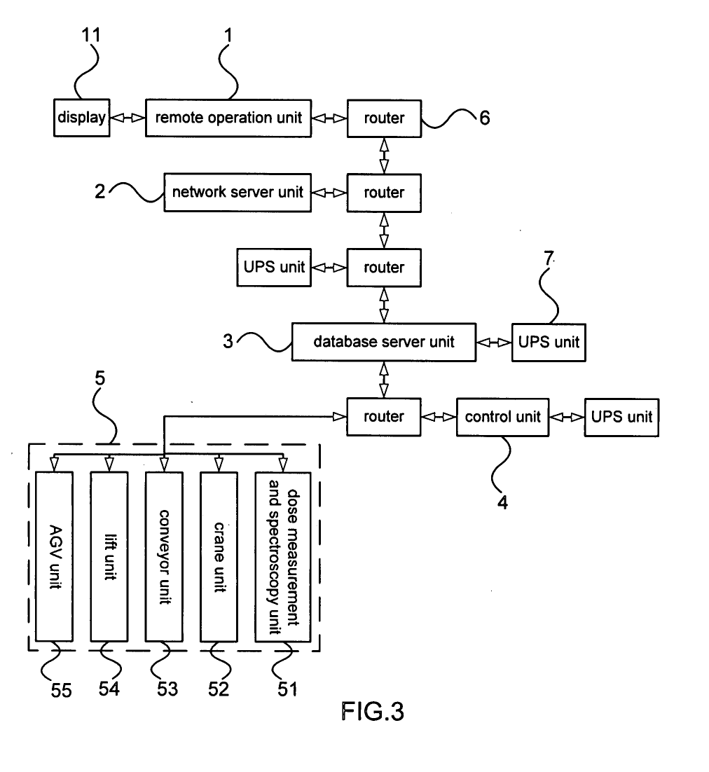

Please refer to FIG. 1 to FIG. 3, which are structural views showing a preferred embodiment, a control unit and an interface unit according to the present invention. As shown in the figures, the present invention is a computerized inventory control system, comprising a remote operation unit 1, a network server unit 2, a database server unit 3, a control unit 4 and an interface unit 5, where the remote operation unit 1, the network server unit 2, the data base server unit 3, the control unit 4 and the interface unit 5 are connected with a router 6 separately; and the network server unit 2, the database server unit 3 and the control unit 4 are connected with an uninterruptible power supply (UPS) unit 7.

The remote operation unit 1 has a plurality of displays 11.

The network server unit 2 is connected with the remote operation unit 1 to be a communication interface for command from the remote operation unit 1.

The database server unit 3 is connected with the network server unit 2 to transfer and store data.

The control unit 4 is connected with the database server unit 3 to receive and transfer command signal from the remote operation unit 1. The control unit 4 comprises a waste entry signal unit 41, a waste removal signal unit 42, a waste move-out signal unit 43, a waste reallocation signal unit 44, a storage status signal unit 45, a system inquiring signal unit 46 and a system activities log signal unit 47.

The interface unit 5 is connected with the control unit 4, comprising a dose rate measurement and gamma spectroscopy unit 51, a crane unit 52, a conveyor unit 53, a lift unit 54 and an AGV unit 55. These units 51, 52, 53, 54, 55 processes command from the control unit 4 and returns status of the processing of the command to the control unit 4. Thus, a novel computerized inventory control system is obtained, where a waste entry operation for a radwaste drum is easily processed with less time and reduced congestion while a whole status is easily monitored, a storage location is easily inquired and a maintenance is easily done.

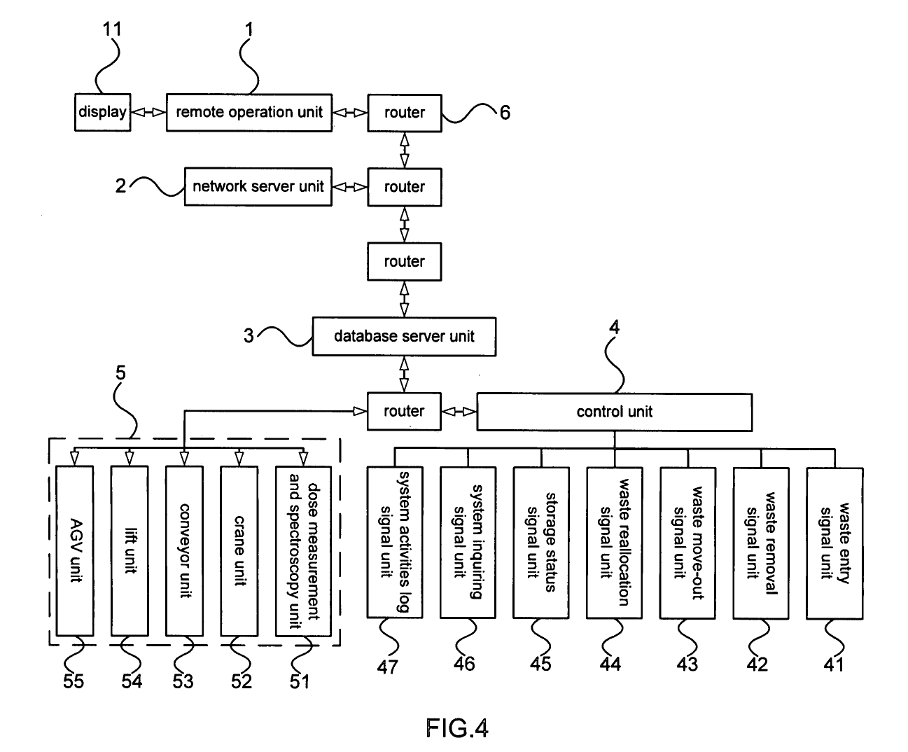

Please refer to FIG. 4, which is a structural view showing a state of use. As shown in the figure, when processing a waste entry process, the control unit 4 sends a waste entry signal from a waste entry signal unit 41. A waste container car loaded with radwaste drums enters into a storehouse and an upper cover of a container is uncovered. A crane unit 52 of an interface unit 5 lifts up a radwaste drum. At this moment, the conveyor unit 53 senses the lifting of the radwaste drum and transfers a signal to the control unit 4 for an operator to command an operation start. The serial number of the radwaste drum is inputted, its appearance is examined, and the examine result is inputted at the control unit 4. Unqualified radwaste drum is retuned back under a command from the operator through the control unit 4. Qualified radwaste drum is sent to a weighting station by the conveyor unit 53 and a following radwaste drum is succeeded. After the weighting, related data is transferred to the control unit 4 automatically by the convey or unit 53 and the radwaste drum is sent to a dose rate measurement and gamma spectroscopy unit 51 to be analyzed. The conveyor unit 53 is connected to the dose rate measurement and gamma spectroscopy unit 51 to transfer data for an operation of a measurement station (e.g. closing a shielding gate of the measurement station). A serial number and a weight of the radwaste drum sent by the control unit 4 is recorded by the dose rate measurement and gamma spectroscopy unit 51. After measuring a smear sampling and a surface dose rate of the radwaste drum, the dose rate measurement and gamma spectroscopy unit 51 automatically transferred a judgment to the control unit 4 on whether the measuring result is qualified. Radwaste drum disqualified on smear sampling is confirmed by the operator to be returned back through the conveyor unit 53 with a command inputted at the control unit 4.

The radwaste drum is a cement-solidified radwaste drum or a dry radwaste drum. A serial number of the radwaste drum is entered at first. The control unit 4 notifies the dose rate measurement and gamma spectroscopy unit 51 to activate the conveyor unit 53 for controlling a nuclides analysis of the cement-solidified radwaste drum; and the analysis result is automatically inputted into the control unit 4. Yet the dry radwaste drum is not processed with the nuclides analysis; the dry rad waste drum is processed with measurements of smear sampling and surface dose rate. Qualified radwaste drum is sent to the crane unit 52.

After the radwaste drum is sent to the crane unit 52, the crane unit 52 is turned on and a signal is transmitted to the control unit 4. The control unit 4 commands to hang the radwaste drum to be put on a platform (i.e. a pallet, not shown in the figure) according to the surface dose rate and the weight of the radwaste drum; and the heavier radwaste drum is put at a center location on a pallet. The control unit 4 notifies the crane unit 52 a location on a pallet, which is recorded by the control unit 4. The crane unit 52 automatically hangs the qualified radwaste drum to be put at the location on the pallet. After the hanging, the crane unit 52 transmits a ready signal to the control unit 4.

When six locations on the platform are loaded with radwaste drums, the control unit 4 commands to transfer data to a forklift type automated guided vehicle (AGV) unit 55, where the data includes floor number and storage location. The passage to the storage location is automatically planned by the AGV unit 55; and the passages planned are recorded daily. The AGV unit 55 transfers data to and receives data from a lift unit 54; and current position of the AGV unit 55 is shown on a display 11 of a remote operation unit 1, together with all abnormal statuses of the lift unit 54, if any, and current floor number. The AGV unit 55 automatically senses whether a gate of the lift unit 54 is open to avoid accident. When the AGV unit 55 enters the lift unit 54, the AGV unit 55 is positioned by an automatic sen sing and the lift unit 54 is notified to close the gate. When arriving at the destined floor, the lift unit 54 opens the gate and notifies the AGV unit 55 the gate is opened. The AGV unit 55 transport the rad waste drums to the desired storage location. After unloading the radwaste drums at the desired storage location, the control unit 4 is notified; an empty platform is obtained from a temporary storage area; and the control unit 4 is notified to refill a new empty platform to the temporary storage area. Then, data of the radwaste drum, including a serial number, a radwaste classification, a weight, a nuclides dose, an entry date, a storage location, etc., are inputted to be stored in a database server unit 3 so that, later, an operator can pile the radwaste drums, check the storage status and process related inquiries by a waste reallocation signal unit 44, a storage status signal unit 45, a system inquiring signal unit 46 and a system activities log signal unit 47 of the control unit 4.

On waste removal or moving-out, the operator commands to remove or move-out rad waste drum through the waste removal signal unit 42 or the waste move-out signal unit 43 at the control unit 4. After the control unit 4 sends the storage location and the floor number of the radwaste drum to the AGV unit 55, the AGV unit 55 transports the platform in front of the crane unit 52 to process appearance examination and nuclides analysis as stated. After the platform is filled with six rad waste drums, the control unit 4 commands to transport the radwaste drums to a move-out area and then the radwaste drums are hung up to a container car. Then the car is processed with a dose rate measurement and the result and related data are recorded and updated by the control unit 4 to the database server unit 3.

In this way, the present invention achieves the following advantages:
1. Waste entry operation of radwaste drum is computerized:

With the present invention, the operator processes a waste entry operation of radwaste drum with ease while time is saved and congestion is reduced.
2. Human resource and operation cost is diminished:

Owing to the computerization, work load is lessened so that the power plant can utilize the human resource more effectively.
3. Status of waste entry is clearly shown:

The control unit and the other units (e.g. conveyor unit, crane unit, AGV unit, lift unit, etc.) are connected to each other through Ethernet so that a real-time status is displayed on a human machine interface of the control unit for an overall control.
4. Storage of radwaste drums is easily inquired and maintained:

A database server unit is stored with serial numbers, radwaste classifications, weights, nuclides doses, entry dates and storage locations of radwaste drums so that it is easy for inquiry, printing and maintenance.

To sum up, the present invention is a computerized inventory control system, where a waste entry operation of radwaste drum is easily processed with less time and reduced congestion while a whole status is easily monitored, a storage status is easily inquired and a maintenance is easily done.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A computerized inventory control system, comprising:
a remote operation unit;
a network server unit, said network server unit being connected with said remote operation unit to be a communication interface of command from said remote operation unit;
a database server unit, said database server unit being connected with said network server unit to transfer data and to store data;
a control unit, said control unit being connected with said database server unit to receive and transfer command signal from said remote operation unit; and
an interface unit, said interface unit being connected with said control unit, said interface unit comprising a dose rate measurement and gamma spectroscopy unit, a crane unit, a conveyor unit, a lift unit and an AGV unit, said interface unit processing command from said control unit and returning status of said processing of said command to said control unit.

2. The system according to claim 1,
wherein said remote operation unit has a plurality of displays.

3. The system according to claim 1,
wherein said remote operation unit, said network server unit, said database server unit, said control unit and said interface unit are connected with a router separately.

4. The system according to claim 1,
wherein said network server unit, said database server unit and said control unit are connected with an uninterruptible power supply unit separately.

5. The system according to claim 1,
wherein said control unit comprises a waste entry signal unit, a waste removal signal unit, a waste move-out signal unit, a waste reallocation signal unit, a storage status signal and a system activities log signal unit.
